(19) United States
(12) Patent Application Publication
(10) Pub. No.: US 2026/0291686 A1
(43) Pub. Date: Sep. 24, 2026

(54) CONFIGURATION AND INDICATION SCHEMES FOR UPLINK TRANSMISSION WITH THREE ANTENNA PORTS

(71) Applicant: ZTE Corporation, Shenzhen (CN)

(72) Inventors: Meng MEI, Shenzhen (CN); Bo GAO, Shenzhen (CN); Ke YAO, Shenzhen (CN); Yang ZHANG, Shenzhen (CN); Zhaohua LU, Shenzhen (CN)

(21) Appl. No.: 19/683,397

(22) Filed: May 20, 2026

Related U.S. Application Data
(63) Continuation of application No. PCT/CN2024/072586, filed on Jan. 16, 2024.

(51) Int. Cl. H04L 5/00; H04W 8/24

(52) U.S. Cl. CPC H04L 5/0051; H04W 8/24

(57) ABSTRACT

A method of wireless communication includes receiving, by a user device from a network device, an indication indicating the user device to perform a transmission using 3 antenna ports; determining, by the user device, the 3 antenna ports associated with at least one sounding reference signal (SRS) resource, wherein a SRS port of the at least one SRS resource is disabled or ignored, the SRS port selected by default or indicated by a signaling including a DCI or RRC; and performing the transmission using the 3 antenna ports.

### CROSS-REFERENCE TO RELATED APPLICATIONS

This application is a continuation and claims priority to International Application No. PCT/CN2024/072586, filed on Jan. 16, 2024, the disclosure of which is hereby incorporated by reference herein in its entirety.

### TECHNICAL FIELD

This document relates to systems, devices and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various methods and apparatus for configuring channel state information reference signals for tracking in wireless communications are provided.

In one example aspect, a method of wireless communication is disclosed. The method comprises receiving, by a user device from a network device, an indication indicating the user device to perform a transmission using 3 antenna ports; and performing the transmission using the 3 antenna ports.

In another example aspect, a method of wireless communication is disclosed. The method comprises transmitting, by a network device to a user device, an indication indicating the user device to perform a transmission using 3 antenna ports; and receiving, from the user device, the transmission using the 3 antenna ports.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1a shows an example that two SRS resources are configured with different SRS (sounding reference signals) port indexes based on some implementations of the disclosed technology.

FIG. 1b shows an example that two SRS resources are configured with the same SRS port indexes.

FIG. 2 shows an example wireless communications network based on some implementations of the disclosed technology.

FIG. 3 is a block diagram of an example of a wireless communication apparatus based on some implementations of the disclosed technology.

FIGS. 4 and 5 are example flowcharts of a wireless communication method based on some implementations of the disclosed technology.

### DETAILED DESCRIPTION

The disclosed technology provides implementations and examples of configuring and indicating schemes for uplink transmissions with multiple antenna ports in wireless communications.

In the uplink (UL) transmission, a number of antenna ports need to be used for the transmission. In some implementations of the disclosed technology, a number of 3 antenna ports are used for UL transmission. The disclosed technology provides implementations as to how to determine the 3 transmitting antenna ports for UL transmission. Some implementations of the disclosed technology are related to determining of the layout of antenna ports, determining whether the 3 antenna ports need to be combined by a number of antenna ports associated with a number of sounding reference signal (SRS) resources, and/or determining which antenna port needs to be ignored or disabled from the number of antenna ports of one or more SRS resources.

In the current specification, for a codebook-based UL transmission, the number of antenna ports or SRS ports configured is 1, 2, 4 or 8 and a number of SRS ports are associated with one SRS resource.

In the current specification, up to SRS ports for one SRS resource can be mapped on one OFDM symbol with one same comb offset and different cyclic shift indexes. For the transmission with 8 antenna ports, two symbols can be used to map the total 8 antenna ports and each symbol can be mapped with up to 4 antenna ports. The SRS ports is mapped on a number of OFDM symbols according to

$${w}_{TDM}^{( {p}_{i} )} ( {l}^{′} ) = \{ \begin{matrix}1 & if {l}^{′} ∈ \{ 0 , 2 , ... , {N}_{symb}^{SRS} - 2 \} and {p}_{i} ∈ \{ 1000 , 1001 , 1004 , 1005 \} \\ 1 & if {l}^{′} ∈ \{ 1 , 3 , ... , {N}_{symb}^{SRS} - 1 \} and {p}_{i} ∈ \{ 1002 , 1003 , 1006 , 1007 \} \\ 0 & otherwise\end{matrix}$$

### Where

$${w}_{TDM}^{( {p}_{i} )} ( {l}^{′} )$$

indicates whether SRS port pᵢ is mapped on symbol l′ or not.

In the current specification, for the UL transmission, the association of PUSCH antenna ports and PTRS needs to be determined. For PUSCH transmission with up to 4 antenna ports, for partial or non-coherent codebook-based transmission, PUSCH antenna port 0 and port 2 share one PTRS port 0, and PUSCH antenna port 1 and port 3 share one PTRS 1.

Unlike the current specification, various implementations of the disclosed technology discuss UL transmission using 3 antenna ports. Various implementations for configuring and indicating uplink transmissions with multiple antenna ports (e.g., 3 antenna ports) are discussed below in more detail.

### Implementation 1

A user equipment (UE) receives an indication from a network device, e.g., gNB, which indicates the UE to transmit a PUSCH (Physical Uplink Shared Channel) by using 3 antenna ports. Upon receiving the indication, the UE determines the 3 antenna ports associated with a number of SRS resources and then the UE transmit the PUSCH using 3 antenna ports. In some implementations, the number of SRS resources can be at least 2.

For configuring/indicating the 3 antenna port transmission, at least one of following implementation or configuration by RRC (radio resource control) is considered:

1) Configure different SRS ports in different SRS resources.

2) Configure the SRS ports of 1 or 2 or 4. In this case, the configuration or indication of 3Tx (3 antenna port transmission) is implemented.
a) 2Tx/4Tx dynamic switching with 3Tx based on UE capability if 3Tx is indicated in DCI (downlink control information), wherein 2Tx means transmission with 2 antenna ports and 4 Tx means transmission with 4 antenna ports.
b) One SRI and TPMI field.
c) Dynamic switching of 2 or 1 SRI field.

3) Configure 3 SRS ports used for transmission.

4) Association between comb index/cyclic shift with 3Tx mode (combination or splitting).

5 More than 2 SRS resources are configured for the uplink transmission

In this case, the uplink transmission is configured without full power mode 2.

In the implementations, more than one SRS resources can be combined as discussed below:

### 1) Combining 2 SRS Resources

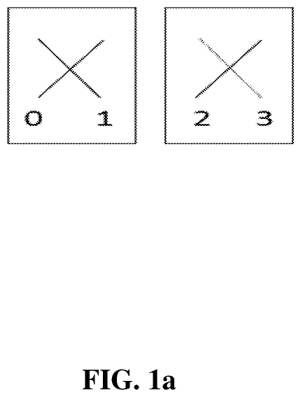

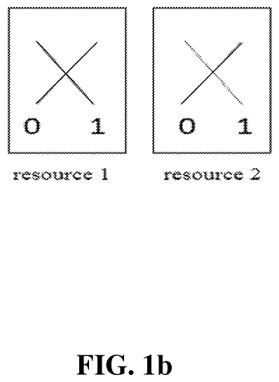

Two SRS resources are combined such that each of the two SRS resources is configured with 2 SRS ports. In this case, one SRS port is disabled (or ignored) to implement a 3-antenna ports PUSCH transmission. In the description below, disabling of the one SRS port refers to any scenario that includes disabling, ignoring, or removing of the one SRS port.
a. Two SRS resources are configured with different SRS port indexes. In the example as shown in FIG. 1a, SRS port 0 and SRS port 1 are configured for resource 1 and SRS port 2 and SRS port 3 are configured for SRS resource 2.
b. Two SRS resources are configured with the same SRS port indexes. In the example as shown in FIG. 1b, SRS port 0 and SRS port 1 are configured for resource 1 and SRS port 0 and SRS port 1 are configured for SRS resource 2.
   2) 4 SRS Ports from 3 or 4 SRS Resources.

For 4 SRS resources, similar to the above case where a total number of 4 SRS ports are supported and one SRS port can be disabled, one SRS port can be disabled to implement a 3 antenna ports transmission.

In the above cases, a total number of 4 SRS ports are supported and one SRS port is disabled. In some other implementations, 3 SRS ports are enabled from the total number of 4 SRS ports. The following two options can be considered as examples of enabling 3 SRS ports:

1) One method is to choose or enable the first 3 antenna ports by default. To implement 3 SRS port, it can disable or ignore or remove the one SRS port of one SRS resource. For example, the last SRS port or SRS port with higher index of the second SRS resource or the last configured SRS resource can be disabled.

2) The other method is to indicate that one SRS port is removed by RRC or DCI signaling. In DCI, a SRI field is used to indicate the related SRS resources and an entry in this field can be used to indicate that the 3-antenna port transmission is combined from antenna ports from 2 SRS resources. For example, an entry of value 2 in Table 1 is used to indicate that two SRS resources are used for the uplink transmission and the SRS ports are combined from the two SRS resources.

In some implementations, the RRC can configure the transmission as discussed in Implementation 1, or can configure the transmitted antenna port as 2. The DCI indicate that the two SRS resources are used for the transmission, and UE will know that the transmission is used for 3-antenna port. In such case, one SRS port can be disabled by default. Or another indication can be implemented using RRC or DCI.

TABLE 1
SRI Indication

| Bit field mapped | SRI(s), |
|---|---|
| to index | N_{SRS} = 2 |
| 0 | 0 |
| 1 | 1 |
| 2 | 0, 1 |

In some implementations, the number of SRS resources is configured as 3. In DCI, a SRI field is used to indicate the related SRS resources. For example, an entry in the SRI field can be used to indicate that the 3-antenna port transmission is combined from antenna ports from 3 SRS resources. For example, an entry of value 3 in Table 2 is used to indicate that 3 SRS resources are used for this transmission and the SRS ports are combined from the 3 resources. In some implementations, the RRC can configure the transmission as discussed in Implementation 1, or can configure the SRS port in each SRS resource as 1. In the example, DCI indicates that the 3 SRS resources are used for the transmission, and UE will know that the transmission is used for 3-antenna port.

TABLE 2
SRI Indication

| Bit field mapped | SRI(s), |
|---|---|
| to index | N_{SRS} = 3 |
| 0 | 0 |
| 1 | 1 |
| 2 | 2 |
| 3 | 0, 1, 2 |

In some implementations, the number of SRS resources is configured as 4. In DCI, a SRI field is used to indicate the related SRS resources and an entry in this field can be used to indicate that the 3-antenna port transmission is combined from antenna ports from 4 SRS resources. For example, an entry of value 4 in Table 3 is used to indicate that 4 SRS resources are used for this transmission and the SRS ports are combined from the 4 resources. In such case, the RRC can configure the transmission as discussed in Implementation 1, or can configure the SRS port in each SRS resource is 1. In the example, DCI indicates that the 4 SRS resources are used for the transmission, and UE will know that the transmission is used for 3-antenna port. If the SRS ports are from 4 SRS resources, one SRS port can be disabled by default. Or another indication can be used as introduced above.

If the number of SRS resources is configured as 4, 3 SRS resources can be used for the 3-antenna port transmission. One method is to select the first 3 SRS resources. In another example, another indication of 3 SRS resources from 4 is used, such as indicated in Table 3 with value 5 or 6 or 7.

TABLE 3
SRI Indication

| Bit field mapped | SRI(s), |
|---|---|
| to index | N_{SRS} = 4 |
| 0 | 0 |
| 1 | 1 |
| 2 | 2 |
| 3 | 3 |
| 4 | 0, 1, 2, 3 |
| 5 | 0, 1, 2 |
| 6 | 0, 2, 3 |
| 7 | 1, 2, 3, |

In some implementations, a new field with 1 bit in DCI can be used to indicate to use the SRS ports from the configured SRS resources to combine a 3-antenna port transmission.

### Implementation 2

In this implementation, the network indicates which three antenna ports are to be used for the transmission. The implementation can further discuss how to indicate which SRS port(S) among configured SRS ports is not used for the transmission.

The RRC or DCI or MAC CE indicates that the transmission is a 3-antenna port transmission. UE will determine the 3 SRS port by default or by one indication. In this implementation, RRC or MAC CE or DCI indicates that which SRS port is not used for the 3 antenna port transmission.

Such as in SRI field in DCI, different entries can indicate different SRS ports that are not used for the transmission and the indicated SRS ports is ignored or disabled for the transmission. For example, in Table 4 below, the new entries (e.g., values 2 to 5) are used to indicate which SRS port is not used for the transmission.

TABLE 4
SRI indication

| Bit field mapped | |
|---|---|
| to index | SRI(s), N_{SRS} = 2 |
| 0 | 0 |
| 1 | 1 |
| 2 | 1^{st} SRS port in 1^{st} resource |
| 3 | 2^{nd} SRS port in 1^{st} resource |
| 4 | 1^{st} SRS port in 2^{nd} resource |
| 5 | 2^{nd} SRS port in 2^{nd} resource |

From Table 4, 2 new bits are needed to indicate 1 SRS port from all the configured SRS ports.

In some implementations, in order to avoid DCI overhead, 1 bit can be used to indicate which SRS port is not used for the transmission. For example, 1 bit is used to indicate that the first SRS port in the second SRS resource or the second SRS port in the second SRS resource is not used for the transmission as shown in Table 5. For example, 1 bit is used to indicate that one SRS port (e.g., the 2nd port in the 1^{st} resource or the second resource) from the first or second SRS resource as shown in Table 6.

TABLE 5
SRI indication

| Bit field mapped | |
|---|---|
| to index | SRI(s), N_{SRS} = 2 |
| 0 | 0 |
| 1 | 1 |
| 2 | 1^{st} SRS port in 2^{nd} resource |
| 3 | 2^{nd} SRS port in 2^{nd} resource |

TABLE 6
SRI indication

| Bit field mapped | |
|---|---|
| to index | SRI(s), N_{SRS} = 2 |
| 0 | 0 |
| 1 | 1 |
| 2 | 2^{nd} SRS port in 1^{st} resource |
| 3 | 2^{nd} SRS port in 2^{nd} resource |

### Implementation 3

For PUSCH transmission, the association of antenna port for SRS and the antenna port for PUSCH needs to be determined.

As one option, the SRS port and antenna port for PUSCH have the same index. If more than 1 SRS resources are configured or indicated for the 3-antenna port transmission, the SRS port indices in different SRS resources are different from one another. For example, the three SRS ports are from two SRS resources, SRS ports #0, 1 are from SRS resource 0, and SRS port #2 are from SRS resource 1. The SRS ports #0, 1, 2 are associated with PUSCH antenna ports, respectively, and the indices of the SRS ports #0, 1, 2 are same as indices of PUSCH antenna ports.

The mapping between SRS ports and PUSCH ports can be based on at least one of: SRS port index in an ascending order, or SRS resource index in an ascending order.

The PUSCH antenna port index is mapped from the lowest SRS port index of the SRS resource with the lowest index. In some cases, the SRS ports in different SRS resources share the same port indexes, e.g. SRS ports #0.1 in SRS resource 0, and SRS ports #0.1 in SRS resource 1. The SRS ports #0.1 for SRS resource 0 are associated with the antenna ports #0.1 for PUSCH, and the SRS port 0 or 1 for SRS resource 1 is associated with PUSCH antenna port 2.

Another method is to indicate a mapping rule for the two SRS resources which SRS resource is associated with the PUSCH antenna port with the lower index.

### Implementation 4

In this implementation, how to indicate PTRS and DMRS ports is discussed.

If the max number of Phase Tracking Reference Signal (PTRS) is configured as one, then all the PUSCH antenna ports share one PTRS port.

In some implementations, for the indication of PTRS and DMRS ports, 2 bits in DCI can be used to indicate which DMRS port is associated with the PTRS port, as shown in Table 5-1.

TABLE 5-1
PTRS-DMRS association

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | Reserved |

In some implementations, for the indication of PTRS and DMRS ports, 1 bit in DCI can be used to indicate which DMRS port is associated with the PTRS port, as shown in Table 5-2.

TABLE 5-2
PTRS-DMRS association

| Value | DMRS port |
|---|---|
| 0 | 1^{st} scheduled DMRS port |
| 1 | 2^{nd} scheduled DMRS port |

For 3 layers transmission, up to 3 DMRS ports can be indicated to UE, only 2 DMRS port can be indicated to be associated with one PTRS port. For codebook-based transmission, the association of DMRS and PUSCH antenna port is indicated according to TPMI. For non-coherent codebook-based transmission, one DMRS port is associated with one PUSCH antenna port. In order to choose 2 DMRS port from the total 3 DMRS ports for the PTRS-DMRS association, several options can be used as follows:
1) The first two DMRS ports are selected as default;
2) The two DMRS ports share the first two PUSCH antenna ports;
3) The two DMRS ports are associated with SRS ports from the first SRS resource;
4) The DMRS ports are associated with the SRS ports from the one SRS resource.

If the max number of PTRS is configured as two, then two antenna ports share one PTRS port, and the other antenna port is associated with another PTRS port.

In the case of the 3 PUSCH antenna ports associated with 3 SRS ports from a total number of 4 SRS ports from one SRS resource, the PUSCH antenna port 0 and 2 are coherent and share one PTRS 0, and another PUSCH antenna port 1 is associated with another PTRS port 1.

For non-coherent codebook-based transmission, one DMRS port is associated with one PTRS port. Hence, the DMRS ports associated with PUSCH antenna port 0 or port 2 share the same PTRS port, and another DMRS port share the other PTRS port. For the indication of PTRS-DMRS association, only the DMRS port from the two DMRS ports share one PTRS needs to be indicated, the other DMRS is associated with the other PTRS port without any indication.

TABLE 5-3
PTRS-DMRS association

| Value | DMRS port |
|---|---|
| 0 | 1^{st} scheduled DMRS port |
| 1 | 2^{nd} scheduled DMRS port |

Another mapping rule is to define which PUSCH antenna port is associated with the PTRS port, i.e. which 2 PUSCH antenna ports are coherent. As introduced above, two PUSCH antenna ports can be treated as coherent, e.g. PUSCH 0,2 or PUSCH 0,1. For the coherent PUSCH antenna port 0,1 or 0,2, the two antenna ports are associated with two SRS ports from one SRS resource and another PUSCH antenna port is associated with the SRS port from another SRS resource.

### Implementation 5

For the UL transmission with 3 antenna ports, if antenna switching is configured, a number of SRS resources need to be configured for DL receiving. For combination of different resources of 3 antenna port transmission, at least two SRS resources are configured for codebook transmission. When antenna switching is configured, two SRS resources can be configured for one SRS resource set on different OFDM symbols.

The same two resources can be used for codebook-based transmission and antenna switching. If 3 antenna port or codebook-based transmission is enabled or configured or indicated, then 3 antenna ports are configured and if antenna switching is configured, then 4 antenna ports are enabled. In such case, the SRS resources can be multiplexed for codebook-based transmission and antenna switching. For example, three or four SRS ports corresponding to two SRS resources are configured or used for UL transmission or antenna switching, SRS ports 0, 1, 2 are used for UL transmission, SRS ports 0, 1, 2, 3 are used for antenna switching.

In another case, two SRS resources are configured for UL transmission, and the one or two SRS ports in one SRS resource (e.g. the second SRS resource) are also used for antenna switching, in such case, at least one other SRS resource is configured for antenna switching.

In some implementations, more than 2 resources can be used for codebook-based transmission or antenna switching. If 3 antenna port or codebook-based transmission is enabled or configured or indicated, then 3 antenna ports from 3 resources are configured; if antenna switching is configured, then 4 antenna ports from 4 SRS resources are enabled. In such case, a plurality SRS resources can be multiplexed for codebook-based transmission and antenna switching.

In some implementations, if 2 SRS resources are configured for 3 antenna port transmission, and 2 SRS ports are configured for each resource or 2 SRS ports and 1 SRS port are configured for the two SRS resources respectively, a total number of 4 SRS resources can be configured for antenna switching, and 3 or 4 SRS ports are configured in the first two SRS resources and the same number of SRS ports are configured in the last SRS resources.

Whether to support 3 antenna port transmission for uplink can be reported as a UE capability.

When a UE supports 3 antenna port transmission, whether it can be configured as ‘1T1R’ or ‘1T2R’ or ‘1T4R’ or ‘2T2R’ or ‘2T4R’ or ‘3T3R’ or ‘3T4R’ or ‘3T6R’ or ‘3T8R’ can be reported as UE capability. ‘xTyR’ means x antenna ports can be used for the UL transmission and y antenna ports can be used for DL reception.

For antenna switching, a guard period needs to be determined. The following configurations of SRS resources can be considered:
1) A same guard period for SRS resources is configured for codebook-based transmission and antenna switching. In such case, the SRS resources for codebook-based transmission and antenna switching is fully or partially multiplexed.
2) The guard period is used for antenna switching, and another guard period with a number of OFDM symbols or no guard period is used for codebook-based transmission. In such case, the SRS resources for codebook-based transmission or antenna switching is determined based on the configured or indicated number of SRS ports.

In some embodiments, antenna port for SRS means SRS ports or SRS antenna port, antenna port for PUSCH means PUSCH port or PUSCH antenna port, the transmission with 3 antenna ports can be PUSCH transmission or SRS transmission.

For the UL transmission with 8 antenna ports, when the transmission layer is configured by RRC or indicated by DCI with no more than 4, 2 bits is used to indicate the PTRS-DMRS association. If only one PTRS is configured, the two bits can be used to indicate the association with the configured or indicated PTRS port. If two PTRS ports are configured, if one PTRS port is share by more than 2 DMRS ports, two bits can be used to indicate the association of the PTRS port and the shared DMRS, the association of the other PTRS port and DMRS ports is indicated by using the same indication in DCI.

For max rank configured by RRC and being no more than 4, up to 4 DMRS ports can be indicated, if the uplink antenna port is configured with more than 4, e.g., 8. For Rel-18 indication, {4+0}, {3+1}, {2+2}, {1+3}, {0+4} are supported, where {4+0} means that 4 DMRS ports share PTRS port 0 and no DMRS ports share PTRS port 1; {3+1} means that 3 DMRS ports share PTRS port 0 and 1 DMRS port shares PTRS port 1; {2+2} means that 2 DMRS ports share PTRS port 0 and 2 DMRS ports share PTRS port 1; {1+3} means that 1 DMRS port shares PTRS port 0 and 3 DMRS ports share PTRS port 1; {0+4} means that 0 DMRS ports share PTRS port 0 and 4 DMRS ports share PTRS port 1:
For {4+0} and {0+4}, the PTRS-DMRS association is indicated by 2 bits, the 2 bits used to indicate which DMRS port from the 4 DMRS ports is associated with the PTRS port 0 or 1, there are no other DMRS ports associated with another PTRS, and the indication can be ignored for PTRS port 1 or 0.
For {3+1} and {1+3}, the PTRS-DMRS association is indicated by 2 bits, 3 DMRS ports share one PTRS, and there is another DMRS port associated with another PTRS. The PTRS-DMRS association is indicated by 2 bits, the 2 bits used to indicate which DMRS port from 3 DMRS port is associated with the PTRS port 0 or 1, there is another DMRS port associated with another PTRS, and the indication can be ignored for PTRS port 1 or 0.
For {2+2}, PTRS port 0 is shared by 2 DMRS ports, and PTRS port 1 is shared by other indicated DMRS ports, 2 bits can only indicate one association, e.g., PTRS port 0 or PTRS port 1, and the other PTRS port follows the same indication.

In some other implementations, 2 bits are used to indicate the PTRS-DMRS association, where each bit is associated with a corresponding PTRS port.
For {4+0} and {0+4}, the PTRS-DMRS association is indicated by 2 bits, 4 DMRS ports share one PTRS port, the 1 bit used to indicate which DMRS port from 2 DMRS ports is associated with the PTRS port 0 or 1, there are no other DMRS ports associated with the other PTRS, and the indication of the other bit can be ignored for PTRS port 1 or 0, where the 2 DMRS ports can be the first 2 of the 4 DMRS ports that share one PTRS port.
For {3+1} and {1+3}, the PTRS-DMRS association is indicated by 2 bits, 3 DMRS ports share one PTRS port and 2 of the 3 DMRS ports can be indicated to be associated with the PTRS port, and there is another DMRS ports associated with another PTRS. The PTRS-DMRS association is indicated by 2 bits, the 1 bit used to indicate which DMRS port from the 2 DMRS ports is associated with the PTRS port 0 or 1, there is another DMRS port associated with another PTRS, and the indication of the other bit can be ignored for PTRS port 1 or 0, where the 2 DMRS ports can be the first 2 of the 3 DMRS ports that share one PTRS port.
For {2+2}, PTRS port 0 is shared by 2 DMRS ports, and PTRS port 1 is shared by the other indicated DMRS, 1 bit can indicate one association of one PTRS port and total 2 bits are used.

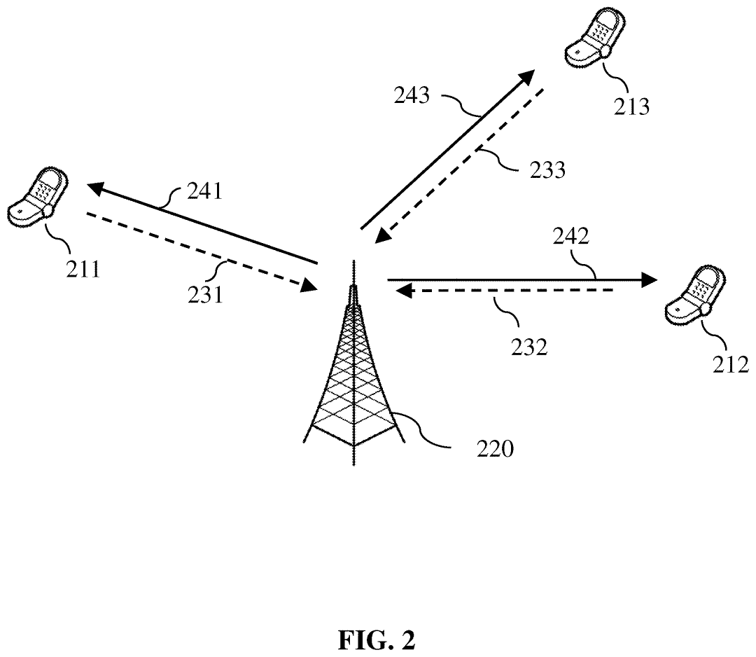

FIG. 2 illustrates an example of a wireless communication system (e.g., a long term evolution (LTE), 5G or NR cellular network) that includes a BS 220 and one or more user equipment (UE) 211, 212 and 213. In some embodiments, the uplink transmissions (231, 232, 233) can include uplink control information (UCI), higher layer signaling (e.g., UE assistance information or UE capability), or uplink information. In some embodiments, the downlink transmissions (241, 242, 243) can include DCI or high layer signaling or downlink information. The UE may be, for example, a smartphone, a tablet, a mobile computer, a machine to machine (M2M) device, a terminal, a mobile device, an Internet of Things (IoT) device, and so on.

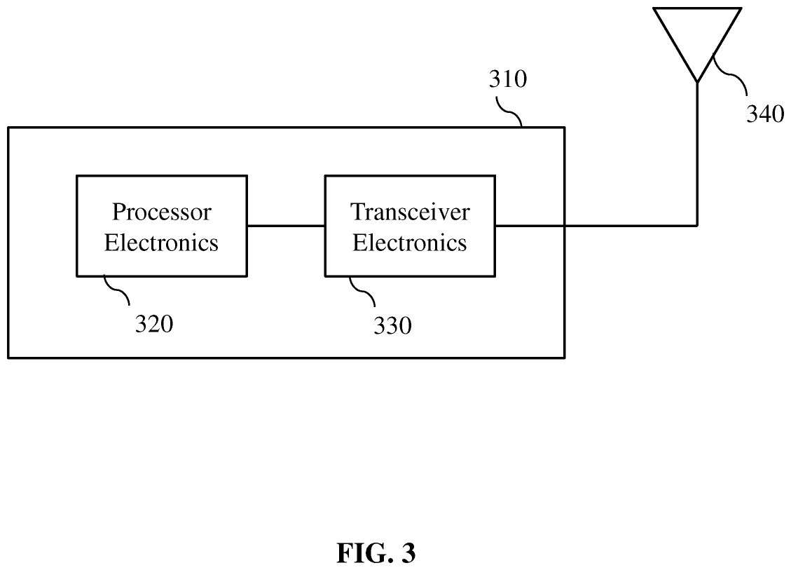

FIG. 3 is a block diagram representation of a portion of an apparatus, in accordance with some embodiments of the presently disclosed technology. An apparatus 310 such as a network device or a base station or a wireless device (or UE), can include processor electronics 320 such as a microprocessor that implements one or more of the techniques presented in this document. The apparatus 310 can include transceiver electronics 330 to send and/or receive wireless signals over one or more communication interfaces such as antenna(s) 340. The apparatus 310 can include other communication interfaces for transmitting and receiving data. Apparatus 310 can include one or more memories (not explicitly shown) configured to store information such as data and/or instructions. In some implementations, the processor electronics 320 can include at least a portion of the transceiver electronics 330. In some embodiments, at least some of the disclosed techniques, modules or functions are implemented using the apparatus 310.

Some preferred embodiments may include the following solutions.

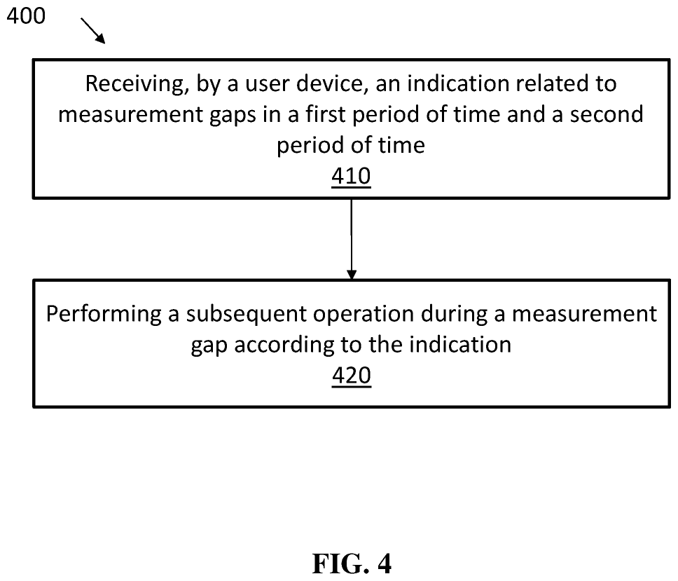

1. A method of wireless communications (e.g., method 400 as shown in FIG. 4), comprising: receiving 410, by a user device from a network device, an indication indicating the user device to perform a transmission using 3 antenna ports; and performing 420 the transmission using the 3 antenna ports.

2. The method of solution 1, comprising: determining, by the user device, the 3 antenna ports associated with a number of SRS (sounding reference signals) resources, wherein at least two SRS resources are combined, each of the at least two SRS resources being configured with 2 SRS ports.

3. The method of solution 2, wherein a SRS port is disabled or ignored, the SRS port selected by default or indicated by a signaling including a DCI or RRC.

4. The method of solution 2, wherein 3 SRS ports are enabled, the 3 SRS ports selected by default or a signaling including RRC, DCI or MAC CE.

5. The method of solution 1, comprising: determining, by the user device, the 3 antenna ports associated with a number of SRS resources, wherein at least two SRS resources are combined such that a first SRS resource is configured with 2 SRS ports and a second SRS resource is configured with another SRS port.

6. The method of solution 1, wherein the indication includes an entry in SRI field indicating that the transmission using the 3 antenna ports is combined from antenna ports from at least two SRS resources.

7. The method of solution 1, wherein the indication includes a 1-bit field in a DCI, the 1-bit field indicating to use SRS ports from configured SRS resources to implement the transmission.

8. The method of solution 1, wherein the indication includes a field with two bit that indicates that i) a first SRS port in a first resource, ii) a second SRS port in the first resource, iii) a first SRS port in a second resource, or iv) a second SRS port in the second resource is not used for the transmission.

9. The method of solution 1, wherein the indication includes a field with one bit that indicates that a first SRS port or a second SRS port in a resource is not used for the transmission or that a SRS port with a same order in a first resource or a second resource is not used for the transmission.

10. The method of solution 1, wherein the 3 antenna ports have same indices as indices of SRS ports.

11. The method of solution 10, wherein if more than 1 SRS resources are configured or indicated for the transmission using the 3 antenna ports, SRS ports in different SRS resources have different indices from each other.

12. The method of solution 1, wherein a mapping between SRS ports and the 3 antenna ports for PUSCH is based on a SRS port index in an ascending order or a SRS resource index in an ascending order.

13. The method of solution 1, wherein if a max number of PTRS is configured as one, the 3 antenna ports share one PTRS port and wherein the indication includes a field with one bit or two bits, the field indicating a DMRS port associated with a PTRS port.

14. The method of solution 13, wherein one bit is used to indicate an association between the DMRS port and the PTRS port, the method further comprises: selecting two DMRS ports from up to three DMRS ports.

15. The method of solution 14, wherein first two DMRS ports are selected as default, two DMRS ports share first two antenna ports, two DMRS ports are associated with SRS ports from a first SRS resource, and/or DMRS ports are associated with SRS ports from one SRS resource.

16. The method of solution 1, wherein if a max number of PTRS is configured as two, two antenna ports share one PTRS port and another antenna port is associated with another PTRS port.

17. The method of solution 16, wherein the indication includes a field with one bit to indicate a DMRS port from two DMRS ports sharing one PTRS without indicating another DMRS associated with another PTRS port.

18. The method of solution 1, wherein two antenna ports of the 3 antenna ports are treated as coherent and the two antenna ports are associated with two SRS ports from a SRS resource.

19. The method of solution 1, wherein SRS resources are multiplexed for a codebook-based transmission and an antenna switching.

20. The method of solution 1, further comprising: reporting a UE capability indicating whether the user device supports the transmission using the 3 antenna ports.

21. The method of solution 20, wherein the UE capability indicates i) x antenna ports allowed used for the transmission and ii) y antenna ports allowed used for a downlink reception for antenna switching, wherein x is an integer being equal to 1, 2, or 3 and y is an integer being equal to 1, 2, 3, 4, 6 or 8.

22. The method of solution 19, wherein a same guard period for SRS resources is configured for the codebook-based transmission and the antenna switching.

23. The method of solution 19, wherein a first guard period is used for the antenna switching a second guard period with a number of OFDM symbols or no guard period is used for the codebook-based transmission.

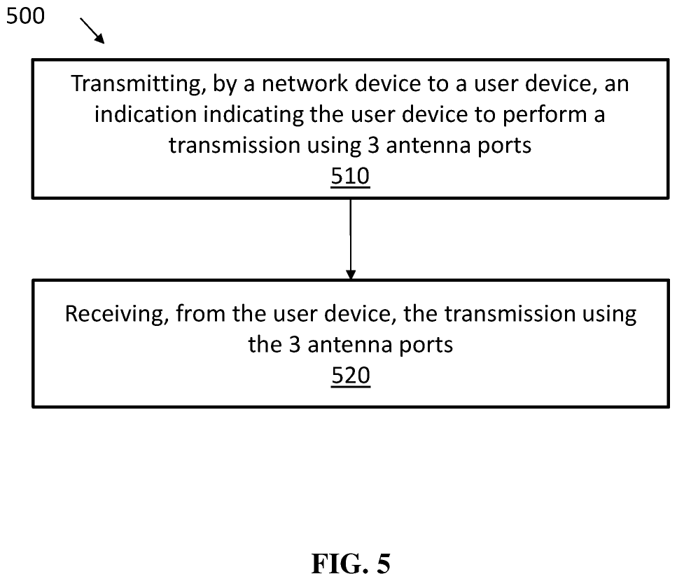

24. A method for wireless communication (e.g., method 500 as shown in FIG. 5), comprising: transmitting, by a network device to a user device, an indication indicating the user device to perform a transmission using 3 antenna ports; and receiving, from the user device, the transmission using the 3 antenna ports.

25. The method of solution 24, wherein the 3 antenna ports are determined to be associated with a number of SRS resources, wherein at least two SRS resources are combined, each of the at least two SRS resources being configured with 2 SRS ports.

26. The method of solution 25, wherein a SRS port is disabled or ignored, the SRS port selected by default or indicated by a signaling including a DCI or RRC, or wherein 3 SRS ports are enabled, the 3 SRS ports selected by default or a signaling including RRC, DCI or MAC CE.

27. The method of solution 24, wherein the 3 antenna ports are determined to be associated with a number of SRS resources, wherein at least two SRS resources are combined such that a first SRS resource is configured with 2 SRS ports and a second SRS resource is configured with another SRS port.

28. The method of solution 24, wherein the indication includes an entry in SRI field indicating that the transmission using the 3 antenna ports is combined from antenna ports from at least two SRS resources, or wherein the indication includes a 1-bit field in a DCI, the 1-bit field indicating to use SRS ports from configured SRS resources to implement the transmission.

29. The method of solution 24, wherein the indication includes a field with two bit that indicates that i) a first SRS port in a first resource, ii) a second SRS port in the first resource, iii) a first SRS port in a second resource, or iv) a second SRS port in the second resource is not used for the transmission.

30. The method of solution 24, wherein the indication includes a field with one bit that indicates that a first SRS port or a second SRS port in a resource is not used for the transmission or that a SRS port with a same order in a first resource or a second resource is not used for the transmission.

31. The method of solution 24, wherein the 3 antenna ports have same indices as indices of SRS ports.

32. The method of solution 31, wherein if more than 1 SRS resources are configured or indicated for the transmission using the 3 antenna ports, SRS ports in different SRS resources have different indices from each other.

33. The method of solution 31, wherein a mapping between SRS ports and the 3 antenna ports for PUSCH is based on a SRS port index in an ascending order or a SRS resource index in an ascending order.

34. The method of solution 24, wherein if a max number of PTRS is configured as one, the 3 antenna ports share one PTRS port and wherein the indication includes a field with one bit or two bits, the field indicating a DMRS port associated with a PTRS port.

35. The method of solution 34, wherein one bit is used to indicate an association between the DMRS port and the PTRS port, the method further comprises: selecting two DMRS ports from up to three DMRS ports.

36. The method of solution 35, wherein first two DMRS ports are selected as default, two DMRS ports share first two antenna ports, two DMRS ports are associated with SRS ports from a first SRS resource, and/or DMRS ports are associated with SRS ports from one SRS resource.

37. The method of solution 24, wherein if a max number of PTRS is configured as two, two antenna ports share one PTRS port and another antenna port is associated with another PTRS port.

38. The method of solution 37, wherein the indication includes a field with one bit to indicate a DMRS port from two DMRS ports sharing one PTRS without indicating another DMRS associated with another PTRS port.

39. The method of solution 24, wherein two antenna ports of the 3 antenna ports are treated as coherent and the two antenna ports are associated with two SRS ports from a SRS resource.

40. The method of solution 24, wherein SRS resources are multiplexed for a codebook-based transmission and an antenna switching.

41. The method of solution 24, further comprising: receiving, from the user device, a report about a UE capability indicating whether the user device supports the transmission using the 3 antenna ports.

42. The method of solution 41, wherein the UE capability indicates i) x antenna ports allowed used for the transmission and ii) y antenna ports allowed used for a downlink reception for antenna switching, wherein x is an integer being equal to 1, 2, or 3 and y is an integer being equal to 1, 2, 3, 4, 6 or 8.

43. The method of solution 40, wherein a same guard period for SRS resources is configured for the codebook-based transmission and the antenna switching.

44. The method of solution 40, wherein a first guard period is used for the antenna switching a second guard period with a number of OFDM symbols or no guard period is used for the codebook-based transmission.

45. A wireless communication apparatus comprising a processor configured to implement a method recited in any of above solutions.

46. A computer storage medium having code stored thereupon, the code, upon execution by a processor, causing the processor to implement a method recited in any of above claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
receiving, by a user device from a network device, an indication indicating the user device to perform a transmission using 3 antenna ports;
determining, by the user device, the 3 antenna ports associated with at least one sounding reference signal (SRS) resource, wherein a SRS port of the at least one SRS resource is disabled or ignored, the SRS port selected by default or indicated by a signaling including a DCI or RRC; and
performing the transmission using the 3 antenna ports.

2. The method of claim 1, wherein the indication includes a 1-bit field in a DCI, the 1-bit field indicating to use the SRS port from configured SRS resources to implement the transmission.

3. The method of claim 1, wherein a mapping between SRS ports and the 3 antenna ports for PUSCH is based on a SRS port index in an ascending order or a SRS resource index in an ascending order.

4. The method of claim 1, wherein if a max number of PTRS is configured as one, the 3 antenna ports share one PTRS port and wherein the indication includes a field with one bit or two bits, the field indicating a DMRS port associated with a PTRS port.

5. The method of claim 4, wherein one bit is used to indicate an association between the DMRS port and the PTRS port, and the method further comprises: selecting two DMRS ports from up to three DMRS ports, or first two DMRS ports are selected as default, two DMRS ports share first two antenna ports, two DMRS ports are associated with SRS ports from a first SRS resource, and/or DMRS ports are associated with SRS ports from one SRS resource.

6. The method of claim 4, wherein two bits are used to indicate an association between the DMRS port and the PTRS port, wherein first three codepoints are used to indicate which DMRS port is associated with the PTRS port, and a last codepoint is reserved.

7. The method of claim 1, wherein if a max number of PTRS is configured as two, two antenna ports share one PTRS port and another antenna port is associated with another PTRS port, and wherein the indication includes a field with one bit to indicate a DMRS port from two DMRS ports sharing one PTRS without indicating another DMRS associated with another PTRS port.

8. The method of claim 1, wherein SRS resources are multiplexed for a codebook-based transmission and an antenna switching, and wherein i) a same guard period for SRS resources is configured for the codebook-based transmission and the antenna switching, or ii) a first guard period is used for the antenna switching a second guard period with a number of OFDM symbols or no guard period is used for the codebook-based transmission.

9. The method of claim 1, further comprising:
reporting a UE capability indicating whether the user device supports the transmission using the 3 antenna ports, wherein the UE capability indicates i) x antenna ports allowed used for the transmission and ii) y antenna ports allowed used for a downlink reception for antenna switching, wherein x is an integer being equal to 1, 2, or 3 and y is an integer being equal to 1, 2, 3, 4, 6 or 8.

10. A method for wireless communication, comprising:
transmitting, by a network device to a user device, an indication indicating the user device to perform a transmission using 3 antenna ports; and
receiving, from the user device, the transmission using the 3 antenna ports,
wherein the 3 antenna ports are determined to be associated with at least one sounding reference signal (SRS) resource, and wherein a SRS port of the at least one SRS resource is disabled or ignored, the SRS port selected by default or indicated by a signaling including a DCI or RRC.

11. The method of claim 10, wherein the indication includes a 1-bit field in a DCI, the 1-bit field indicating to use the SRS port from configured SRS resources to implement the transmission.

12. The method of claim 10, wherein a mapping between SRS ports and the 3 antenna ports for PUSCH is based on a SRS port index in an ascending order or a SRS resource index in an ascending order.

13. The method of claim 10, wherein if a max number of PTRS is configured as one, the 3 antenna ports share one PTRS port and wherein the indication includes a field with one bit or two bits, the field indicating a DMRS port associated with a PTRS port.

14. The method of claim 13, wherein one bit is used to indicate an association between the DMRS port and the PTRS port, the method further comprises: selecting two DMRS ports from up to three DMRS ports.

15. The method of claim 14, wherein first two DMRS ports are selected as default, two DMRS ports share first two antenna ports, two DMRS ports are associated with SRS ports from a first SRS resource, and/or DMRS ports are associated with SRS ports from one SRS resource, or wherein two bits are used to indicate an association between the DMRS port and the PTRS port, wherein first three codepoints are used to indicate which DMRS port is associated with the PTRS port, and a last codepoint is reserved.

16. The method of claim 10, wherein if a max number of PTRS is configured as two, two antenna ports share one PTRS port and another antenna port is associated with another PTRS port, and wherein the indication includes a field with one bit to indicate a DMRS port from two DMRS ports sharing one PTRS without indicating another DMRS associated with another PTRS port.

17. The method of claim 10, wherein SRS resources are multiplexed for a codebook-based transmission and an antenna switching, and wherein i) a same guard period for SRS resources is configured for the codebook-based transmission and the antenna switching, or ii) a first guard period is used for the antenna switching a second guard period with a number of OFDM symbols or no guard period is used for the codebook-based transmission.

18. The method of claim 10, further comprising:
receiving, from the user device, a report about a UE capability indicating whether the user device supports the transmission using the 3 antenna ports, wherein the UE capability indicates i) x antenna ports allowed used for the transmission and ii) y antenna ports allowed used for a downlink reception for antenna switching, wherein x is an integer being equal to 1, 2, or 3 and y is an integer being equal to 1, 2, 3, 4, 6 or 8.

19. A wireless communication apparatus comprising processor electronics configured to:
receive, from a network device, an indication indicating the wireless communication apparatus to perform a transmission using 3 antenna ports;
determine the 3 antenna ports associated with at least one sounding reference signal (SRS) resource, wherein an SRS port of the at least one SRS resource is disabled or ignored, the SRS port selected by default or indicated by a signaling including a DCI or RRC; and
perform the transmission using the 3 antenna ports.

20. The wireless communication apparatus of claim 19, wherein the indication includes a 1-bit field in a DCI, the 1-bit field indicating to use the SRS port from configured SRS resources to implement the transmission, or wherein a mapping between SRS ports and the 3 antenna ports for PUSCH is based on an SRS port index in an ascending order or a SRS resource index in an ascending order.
